(19) United States
(12) Patent Application Publication
(10) Pub. No.: US 2006/0236868 A1
(43) Pub. Date: Oct. 26, 2006

(54) Dessicant container

(76) Inventors: Bester Pansegrouw, Ottery (ZA); Morkel Van Der Westhuizen, Ottery (ZA)

Correspondence Address: STITES & HARBISON PLLC, 1199 NORTH FAIRFAX STREET, SUITE 900, ALEXANDRIA, VA, 22314, US

(21) Appl. No.: 10/557,776

(22) PCT Filed: Jan. 15, 2004
(86) PCT No.: PCT/IB04/00077

§ 371 Date: Jul. 3, 2006

(30) Foreign Application Priority Data
May 19, 2003 (ZA) 2003/3842

(51) Int. Cl. B01D 53/02

(52) U.S. Cl. 96/134

(57) ABSTRACT

The present invention discloses a desiccant container (10), which includes a first sheet (12), made of non-porous packaging material, for surrounding at least partially a desiccant material (14); a second sheet (16), made of at least two non-laminated porous packaging materials (20, 22), for surrounding at least partially the desiccant material (14). The two non-laminated porous packaging materials (20, 22) consist of different materials. The first sheet (12) consists of at least one layer of a mono-layered film material (18) and/or a co-extruded material.

### FIELD OF INVENTION

The present invention relates to desiccant containers.

More particularly, the invention relates to desiccant containers containing desiccant materials.

### BACKGROUND TO INVENTION

Desiccant container hold substances of a hygroscopic nature, capable of absorbing moisture and therefore used as drying agents; e.g. anhydrous sodium sulphate, anhydrous calcium chloride, silica gel and phosphorous pentoxide. Generally these containers consist of a water vapour permeable packaging material formed of fibrous or film products sealed at the edges.

For example, U.S. Pat. No. 5,743,942 Shelley et al discloses a desiccant container comprising a laminated desiccant packaging material and an uncoated micro-porous film sealed to an uncoated laminate film with the uncoated micro-porous film consisting of a different composition from the uncoated laminate film.

It is an object of the invention to suggest a novel desiccant container.

### SUMMARY OF INVENTION

According to the invention, a desiccant container, includes
(a) a first sheet, made of non-porous packaging material, for surrounding at least partially a desiccant material;
(b) a second sheet, made of at least two non-laminated porous packaging materials, for surrounding at least partially the desiccant material.

The two non-laminated porous packaging materials may consist of different materials.

The first sheet may be laminated or non-laminated.

The first sheet may consists of at least one layer of a mono-layered film material and/or a co-extruded material.

The co-extruded material may include a high melting temperature co-extrusion material and/or a low melting temperature co-extrusion material.

The second sheet may include at least one uncoated micro-porous film.

The second sheet may include at least one of the materials selected from the group consisting of polyethylene material, polypropylene, polyolefin material, uncoated poly-olefenic polyethylene material, TYVEK® and Espoir®.

The second sheet may be water vapour permeable.

The desiccant material may include at least one material selected from the group consisting of calcium chloride, starch, clay and a super absorbent.

The desiccant material may include a cationic super absorbent.

The desiccant material may include calcium chloride provided in the form of granules.

The first sheet may be heat sealed to the second sheet.

The desiccant container may include an absorption indicator for indicating the degree of water absorption by the desiccant material.

The adsorption indicator may include visual means.

The adsorption indicator may include discolouration means.

The first sheet and/or the second sheet may be provided with a transparent part for viewing the adsorption indicator.

The desiccant container may be provided with a fragrance.

The fragrance may resemble a flower fragrance.

The desiccant container may include adhesive means for locating or mounting or fixing the desiccant container to inner walls of container's and/or adjacent products.

The adhesive means may be a strip on the exterior of the desiccant container.

The desiccant container may include a removable non-porous material for covering the second sheet.

The removable non-porous material may include at least one material selected from the group consisting of a laminated film, a coated material and a mono-layer film.

The removable non-porous material may be non-breathable material.

Printing and/or adhesive may be provided on the second sheet.

The printing and application of adhesive may occur simultaneously.

The removable non-porous material may be heat-sealed or cold-sealed or glued to the second sheet.

The heat-sealing or cold-sealing or glueing may occur after the printing.

The removable non-porous material may be pealed-off from the second sheet.

The removable non-porous material may consist of polyester and/or polyethylene.

### BRIEF DESCRIPTION OF DRAWINGS

The invention will now be described by way of example with reference to the accompanying schematic drawings.

In the drawings there is shown in:

FIG. 1: a sectional side view of a first embodiment example of a desiccant container in accordance with the invention; and

FIG. 2: a sectional side view of a second embodiment example of a second desiccant container in accordance to the invention.

### DETAILED DESCRIPTION OF DRAWINGS

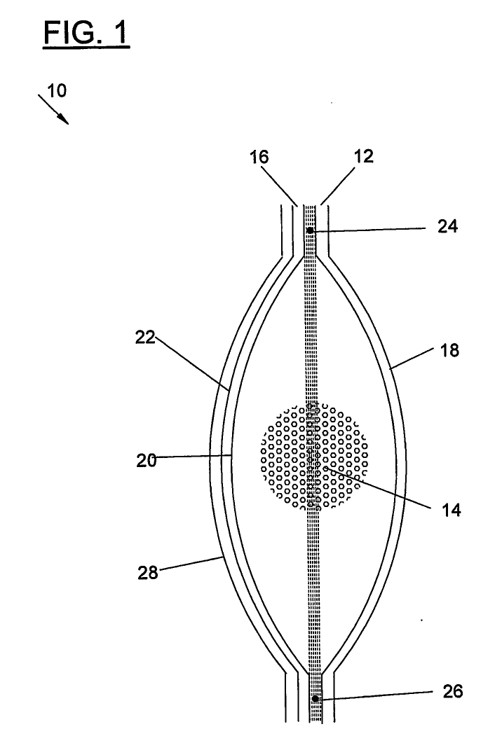

Referring to FIG. 1, a first embodiment example of a first desiccant container in accordance with the invention, generally indicated by reference numeral 10, is shown.

The desiccant container 10 includes a first sheet made of non-laminated packaging material 12 for surrounding at least partially a desiccant material 14, and a second sheet made of porous packaging material 16 for also surrounding at least partially the desiccant material 14.

The first non-laminated packaging material 12 is generally non-porous. The first non-laminated packaging material 12 consists of a mono-layered film material 18.

The second porous packaging material 16 consists of two layers of uncoated micro-porous film 20 and 22. The uncoated micro-porous films 20 and 22 are formed of polyethylene material. The uncoated micro-porous films 20 and 22 are water vapour permeable.

The desiccant material 14 consists of calcium chloride.

The first non-laminated packaging material 12 is heat sealed to the second porous packaging material 16 at the edge indicated by dots 24 and 26.

A removable laminated material 28 is also provided to cover the second porous packaging material 16 in order to prevent the desiccant material 34 from absorbing water. The removable laminated material 28 is generally made of polyester and polyethylene.

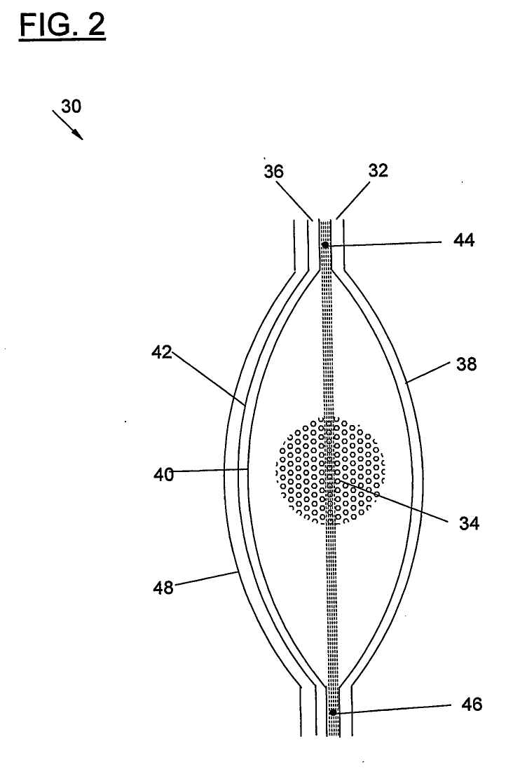

Referring to FIG. 2, a second embodiment example of a second desiccant container in accordance with the invention, generally indicated by reference numeral 30, is shown.

The desiccant container 30 includes a first sheet made of non-laminated packaging material 32 for surrounding at least partially a desiccant material 34, and a second sheet made of porous packaging material 36 for also surrounding at least partially the desiccant material 34.

The first non-laminated packaging material 32 is generally non-porous. The first non-laminated packaging material 32 consists of a co-extruded non-porous material 38.

The second porous packaging material 36 consists of an uncoated micro-porous films 40 and 42. The uncoated micro-porous films 40 and 42 are formed of polyethylene material. The uncoated micro-porous films 40 and 42 are water vapour permeable.

The desiccant material 34 consists of calcium chloride.

The first non-laminated packaging material 32 is heat sealed to the second porous packaging material 16 at the edge indicated by dots 44 and 46.

A removable laminated material 48 is also provided to cover the second porous packaging material 16 in order to prevent the desiccant material 34 absorbing water. The removable laminated material 48 is generally of polyester and polyethylene.

### LIST OF REFERENCE NUMERALS

10 Desiccant container
12 First non-laminated packaging material
14 Desiccant material
16 Second porous packaging material
18 Mono-layered film material
20 Uncoated micro-porous film
22 Uncoated micro-porous film
24 Edge
26 Edge
28 Removable non-porous material
30 Desiccant container
32 First non-laminated packaging material
34 Desiccant material
36 Second porous packaging material
38 Mono-layered film material
40 Uncoated micro-porous film
42 Uncoated micro-porous film
44 Edge
46 Edge
48 Removable non-porous material

1-29. (canceled)

30. A desiccant container, which includes
(a) a first sheet, made of non-porous packaging material, for surrounding at least partially a desiccant material;
(b) a second sheet, made of at least one non-laminated porous packaging materials and at least one micro-porous packaging material, for surrounding at least partially the desiccant material.

31. A desiccant container as claimed in claim 30, in which the two non-laminated porous packaging materials consist of different materials.

32. A desiccant container as claimed in claim 30, in which the first sheet is laminated or non-laminated.

33. A desiccant container as claimed in claim 30, in which the first sheet consists of at least one layer selected of the group comprising a mono-layered film material and a co-extruded material.

34. A desiccant container as claimed in claim 33, in which the co-extruded material includes a high melting temperature co-extrusion material.

35. A desiccant container as claimed in claim 33, in which the co-extruded material includes a low melting temperature co-extrusion material.

36. A desiccant container as claimed in claim 30, in which the second sheet includes at least one uncoated micro-porous film.

37. A desiccant container as claimed in claim 30, in which the second sheet includes at least one of the materials selected from the group consisting of polyethylene material, polypropylene, polyolefin material, uncoated poly-olefenic polyethylene material, TYVEK® and ESPOIR®.

38. A desiccant container as claimed in claim 30, in which the second sheet is water vapour permeable.

39. A desiccant container as claimed in claim 30, in which the desiccant material includes at least one material selected from the group consisting of calcium chloride, starch, clay and a super absorbent.

40. A desiccant container as claimed in claim 30, which includes a cationic super absorbent.

41. A desiccant container as claimed in claim 30, in which the desiccant material includes calcium chloride provided in the form of granules.

42. A desiccant container as claimed in claim 30, in which the first sheet is heat sealed to the second sheet.

43. A desiccant container as claimed in claim 30, which includes an absorption indicator for indicating the degree of water absorption by the desiccant material.

44. A desiccant container as claimed in claim 43, in which the adsorption indicator includes visual means.

45. A desiccant container as claimed in claim 43, in which the adsorption indicator includes discolouration means.

46. A desiccant container as claimed in claim 43, in which a transparent part for viewing the adsorption indicator is provided in at least one of the sheets selected from the group comprising the first sheet and the second sheet.

47. A desiccant container as claimed in claim 30, in which the desiccant container is provided with a fragrance.

48. A desiccant container as claimed in claim 47, in which the fragrance resembles a flower fragrance.

49. A desiccant container as claimed in claim 30, which includes adhesive means for locating the desiccant container to at least one object selected from the group comprising an inner wall of a container and an adjacent product.

50. A desiccant container as claimed in claim 30, which includes adhesive means for mounting the desiccant container to at least one object selected from the group comprising an inner wall of a container and an adjacent product.

51. A desiccant container as claimed in claim 30, which includes adhesive means for fixing the desiccant container to at least one object selected from the group comprising an inner wall of a container and an adjacent product.

52. A desiccant container as claimed in claim 49, in which the adhesive means is a strip on the exterior of the desiccant container.

53. A desiccant container as claimed in claim 50, in which the adhesive means is a strip on the exterior of the desiccant container.

54. A desiccant container as claimed in claim 51, in which the adhesive means is a strip on the exterior of the desiccant container.

55. A desiccant container as claimed in claim 30, which includes a removable non-porous material for covering the second sheet.

56. A desiccant container as claimed in claim 55, in which the removable non-porous material includes at least one material selected from the group consisting of a laminated film, a coated material and a mono-layer film.

57. A desiccant container as claimed in claim 55, in which the removable non-porous material is non-breathable material.

58. A desiccant container as claimed in claim 30, in which printing is provided on the second sheet.

59. A desiccant container as claimed in claim 58, in which the printing and application of an adhesive occurs simultaneously.

60. A desiccant container as claimed in claim 55, in which the removable non-porous material is heat-sealed to the second sheet.

61. A desiccant container as claimed in claim 55, in which the removable non-porous material is cold-sealed to the second sheet.

62. A desiccant container as claimed in claim 55, in which the removable non-porous material is glued to the second sheet.

63. A desiccant container as claimed in claim 30, in which at least one of the steps selected from the group comprising heat-sealing, cold-sealing and glueing occurs after any printing step.

64. A desiccant container as claimed in claim 55, in which the removable non-porous material is pealed-off from the second sheet.

65. A desiccant container as claimed in claim 55, in which the removable non-porous material consists of polyester.

66. A desiccant container as claimed in claim 55, in which the removable non-porous material consists of polyethylene.
